(19) United States
(12) Patent Application Publication
(10) Pub. No.: US 2002/0049634 A1
(43) Pub. Date: Apr. 25, 2002

(54) Interactive quiz based internet system

(76) Inventor: Joseph Longinotti, San Francisco, CA (US)

Correspondence Address: FLEHR HOHBACH TEST ALBRITTTON & HERBERT LLP, Suite 3400, Four Embarcadero Center, San Francisco, CA, 94111-4187, US

(21) Appl. No.: 09/899,830

(22) Filed: Jul. 5, 2001

Related U.S. Application Data
(60) Provisional application No. 60/216,266, filed on Jul. 6, 2000.

(51) Int. Cl. G06F 17/60; G09B 3/00

(52) U.S. Cl. 705/14; 705/10; 434/332

(57) ABSTRACT

The invention relates to an interactive quiz based internet system that provides for the release of stored prize points to a user after the user has completed an educational quiz.

This application claims priority to U.S. Ser. No. 60/216,266 filed Jul. 6, 2000.

### FIELD OF THE INVENTION

The invention relates to an interactive quiz based internet system that provides for the release of stored prize points to a user after the user has completed an educational quiz.

### BACKGROUND OF THE INVENTION

Educational efforts over the Internet are one of the largest growth areas on the Web. A recent article suggested that private investment in educational related Internet ventures is growing at a compound annual rate of 113%. Internet retail sales currently represent less than one percent of all retail sales in the U.S.

The total dollar value of the teen retail market (retail and ecommerce) in the U.S. is approximately 153 billion dollars, with 50 billion representing direct teen spending and 100 billion as influenced spending. The online portion of these sales is less than 1 percent, due, in part, to the lack of liquidity of teens. Generally they must use a parent's credit card to purchase on the Internet.

Accordingly, it is an object of the invention to provide an educational Internet service that allows for the simultaneous education of the teen users as well as the creation and facilitation of liquidity for teen spending on the Internet and elsewhere in the marketplace.

### SUMMARY OF THE INVENTION

In accordance with the objects outlined above, the present invention provides an Internet system method of releasing stored prize points to at least one user upon the user's completion of at least one quiz. The method comprises providing prize points to a user's account and providing a menu of quiz choices to the user. The user then chooses a first quiz and completes it. The system then scores the quiz and returns a final score to the user. The system determines whether the final score is above a threshold score, and if it is, the system releases prize points to the user.

In one aspect, each quiz comprises an information section comprising a number of facts and a set of questions about the facts.

In an additional aspect, the prize points are initially deposited in a user's account by a sponsor or contributor.

In a further aspect, the method further comprises the system providing a menu of prizes to the user and the user spending the prize points.

### BRIEF DESCRIPTION OF THE DRAWINGS

FIG. 1 depicts a schematic overview of the present invention.

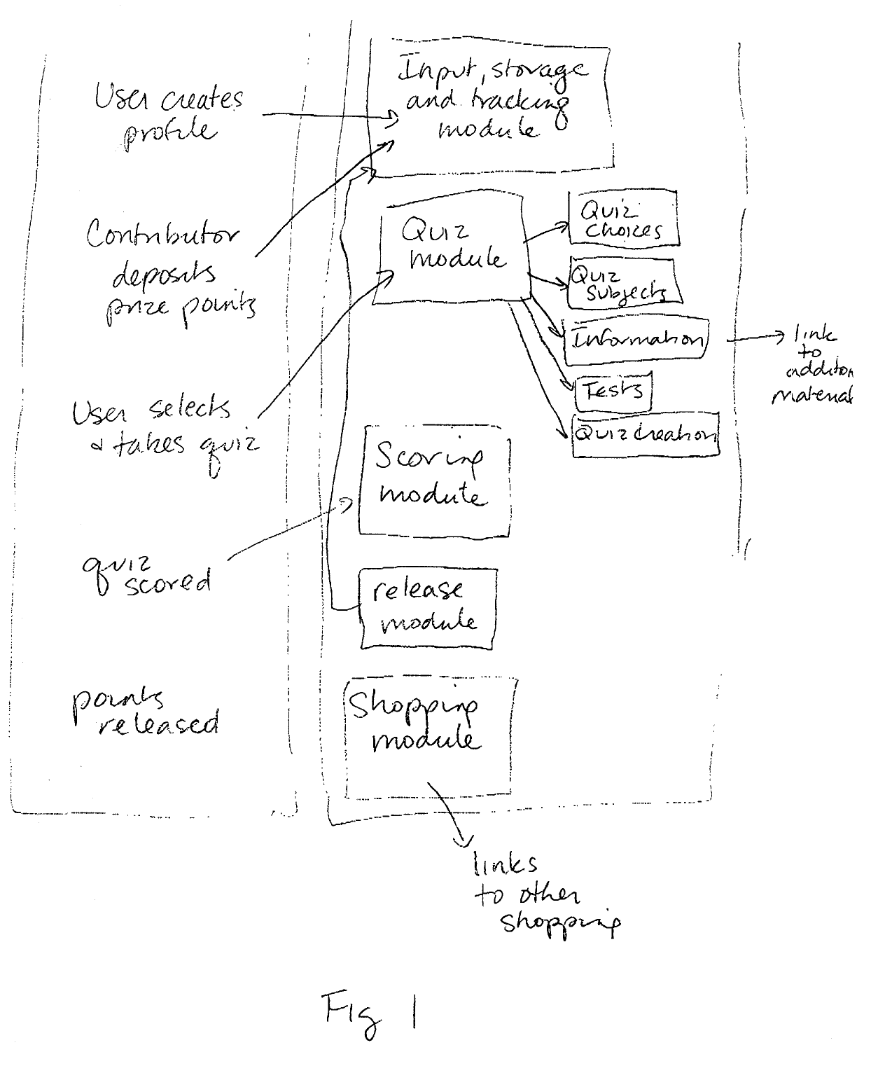

### DETAILED DESCRIPTION OF THE INVENTION

The desire of the teen market to engage the Internet, particularly in the areas of merchandising and shopping, is great. However, due to the absence of a credit vehicle (credit liquidity), teens as a group lack the means to conduct electronic business. The present invention is designed to provide methods wherein teens, with the consent and control of their parents, get prepaid access to Internet shopping opportunities in the context of an education environment.

The web-based Internet system is designed to allow the deposit of limited credit liquidity (e.g. prize points or dollar amounts) by a contributor (e.g. parents, grandparents, relatives, etc.) into a user's account (sometimes referred to as an “educational escrow™”. In order to have those prize points released for use in shopping, the user must take a quiz comprising an informational section about a particular subject, followed by a series of questions that the user must answer. Upon completion of the quiz, the answers are scored by the system and a final score returned. If the score is high enough, the system releases the prize points to the user, who is then free to “spend” them in a variety of ways; either within a shopping module within the system itself, or outside the system at other Internet sites.

Accordingly, the present invention is directed to an Internet system method of releasing stored prize points to a user upon the user's completion of a quiz. The Internet system, as outlined herein and depicted in the figures, comprises a number of modules.

In a preferred embodiment, the system comprises an input and storage module to create and store user profiles. User profiles can comprise any number of elements, including, but not limited to, the age of the user, the sex of the user, the user's grade level, if applicable, the user's geographical location, user preferences such as favorite study areas (math, science, etc.) or weakness areas, socioeconomic information, past quiz information and scores, etc. The user profile includes information about the user's account of prize points, including points deposited but not yet released, and released points. Thus, in one embodiment, the internet system provides a storage and tracking module may be viewed by the user, a contributor, or a system administrator. In addition, security systems such as passwords may be associated with each user profile, to prevent other users, other contributors or non-users to view other's information. This tracking module may be part of the input and storage module as well.

“Users” in this context can be any individual, with children and teens being preferred (9-19, with the 12-17 teen range being particularly preferred). Similarly, “contributors” can be any individual that will deposit prize points to a user's account.

One or more contributors can deposit prize points (sometimes referred to as QuizDollars™) into a user's account. Generally this is a dollar amount.

The Internet system of the invention further provides a quiz module. The quiz module includes a number of components, including, but not limited to, a quiz choice submodule, a quiz subject submodule, a quiz information section submodule, and a question submodule, although as will be appreciated by those in the art, these submodules may be combined.

In one embodiment, the quiz choice submodule filters the quizzes available for a particular user to take. This may be done in a wide variety of ways, as will be appreciated by those in the art. For example, age appropriate quizzes will be offered, such that quizzes that are either too hard or too easy (resulting in the release of prize points too easily) are not offered as quiz options. Similarly, user profiles may include information about a user's academic strengths and weaknesses, and offer quizzes appropriately (e.g. quizzes in weak areas, or putting a limit on how many quizzes in strength or favorite areas a user may take). Thus, the quiz choice submodule may interface with the storage and tracking module.

In one embodiment, the system, the use or the contributor may select the quiz subject after reviewing a history of quizzes already taken by the user, and optionally the final scores of those quizzes.

Alternatively, the user can choose the quiz type, subject matter, etc.

In one embodiment, the quiz choice submodule randomly picks an age appropriate quiz.

Thus, the system provides a menu of quiz choices to the user or sponsor. The user or sponsor then chooses a quiz from the selection list provided from the menu. The chosen quiz is then loaded into the user interface.

The quizzes generally comprise at least two components: an information section and a set of quiz questions. As will be appreciated by those in the art, the information section of the quiz based system can comprise a wide variety of materials, and can be gathered or collected into the module from a wide variety of sources, including, but not limited to, encyclopedias, on-line training materials, educational books and materials, teacher materials, textbooks, standardized testing materials and preparation materials (SAT, etc.), etc.

In a preferred embodiment, the information and quizzes comprise materials relating to traditional academic subjects, including, but not limited to, reading (fluency, comprehension, etc.), spelling and vocabulary, writing (mechanics, including word choices, fluency, conventions and quality, including ideas, voice, organization), mathematics (including computation, problem solving and application, math communication), social studies and science (history, geography, geology, chemistry, biology, zoology, physics, anatomy, botany, etc.).

In a preferred embodiment, the information and quizzes include more non-traditional concepts, including conflict resolution techniques, anger management and control, leadership, debate techniques, stress management skills, moral and religious materials, engineering materials, computer skills including typing, money management and business skills, investing, and medical issues including problems, diseases, history, warning signs, prevention, treatment, prognosis (for example, information on heart disease, diabetes, etc., for children with the diseases or at risk), etc.

The information submodule may provide the information directly, or may provide a link to a different website that contains material to review. Thus, in either case, informational material is provided, generally comprising a number of facts that the user must review prior to taking the quiz.

In some cases, to encourage retention of the information, there may be a time delay between the review of the information and the quiz.

In a preferred embodiment, there may be different “types” of quizzes. For example, simple quizzes utilizing a single source of information followed a set of questions is generally preferred. However, in some cases, “survey quizzes” may require the reading of a series of materials on a more encompassing subject. Furthermore, contributors may also create “custom quizzes” using her own materials, using a quiz creation wizard with standard templates; for example, these may include particular study weaknesses of a child, family histories, etc. Similarly, teachers may help create quizzes based on particular extracurricular work, etc.

The quiz module also includes the question set submodule, which contains the actual quiz questions for each information set. The number of questions will vary widely, depending on the subject, the age of the user, the amount of prize points to be awarded, etc., but will generally be from 5 to 50 questions, with from 5 to 15 being preferred.

The questions can be in a wide variety of formats, including multiple choice, fill in the blanks, writing sentences, drawing answers, etc., and any number of other possible interfaces.

The system further includes a scoring module, that scores the answers the user has provided with a correct set of answers. If the final score reaches a particular threshold, the prize points are released to the user for immediate spending. The threshold may be adjusted or set by the contributor or the system, depending on the age of the user, the complexity of the material, the length of the quiz, etc. Thus, for example, in some cases only perfect scores may cause release of the prize points; in other cases, 90% correct may be sufficient, etc.

If the threshold is not reached, the user may be allowed to retake the quiz, in some embodiments. In some embodiments, there may be an enforced time lag, or they may be able to retake the quiz immediately.

In a preferred embodiment, the system further comprises a shopping module, comprising merchandise for sale using the prize points. As will be appreciated by those in the art, the merchandise can comprise a wide variety of materials, including, but not limited to, music (CDs, tapes), movies (VHS, DVD), books, toys, clothing, convenience items (phone cards, gift certificates to stores or other websites), games (board games, PlayStation™, Nintendo™, GameBoy™, computer games, etc), bikes, sporting equipment, etc.

Alternatively, the shopping module can include portals or links to other websites for shopping. In some instances, the other website servers recognize and accept the prize points of the present invention and allow direct purchasing.

In addition, the user may choose to “bank” the prize points to accumulate larger amounts to save for larger items, or just to save them for shopping at a later time. These are stored in the user's account as part of the user profile.

I claim:

1. An internet system method of releasing stored prize points to at least one user upon said user's completion of at least one quiz, said method comprising:
a) providing prize points to a user's account;
a) providing a menu of quiz choices to said user;
b) said user choosing a first quiz and completing said first quiz;
c) said system scoring said quiz and returning a final score to said user;
d) said system determining whether said final score is above a threshold score, and if it is, said system releasing prize points to said user.

2. A method according to claim 1 wherein each quiz comprises:
a) an information section comprising a number of facts; and
b) a set of questions about said facts.

3. A method according to claim 1 wherein said prize points are initially deposited in a user's account by a contributor and access to those specific deposited points are conditioned upon the user successfully completing and educational quiz or challenge selected by that contributor.

4. A method according to claim 1 further comprising:
a) said system providing a menu of prizes to said user;
b) said user spending said prize points to purchase at least one prize.
